(19) United States
(12) Patent Application Publication
(10) Pub. No.: US 2012/0207419 A1
(43) Pub. Date: Aug. 16, 2012

(54) ROLLING BODY CAGE FOR A BALL BEARING

(75) Inventors: Wolfgang Fugel, Nuernberg (DE); Alexander Reimchen, Herzogenaurach (DE)

(73) Assignee: SCHAEFFLER TECHNOLOGIES AG & CO. KG, Herzogenaurach (DE)

(21) Appl. No.: 13/500,949

(22) PCT Filed: Sep. 6, 2010
(86) PCT No.: PCT/EP2010/063004

§ 371 Date: Apr. 9, 2012

(30) Foreign Application Priority Data
Oct. 9, 2009 (DE) 102009 048 875.8

(51) Int. Cl. F16C 33/38; B23P 11/00; B21D 53/12

(52) U.S. Cl. 384/528; 72/324; 29/898.064

(57) ABSTRACT

A rolling body cage for a hall bearing in the form of a ring with receptacles, which are distributed over the circumference of the cage, for retaining and guiding rolling bodies. The receptacles are formed as cutouts which form spherically curved encircling retaining edges that are matched to the spherical surface of the rolling bodies and at which the rolling bodies can be snapped, in a self-retaining manner, in the cutouts such that they can be engaged around by the retaining edges.

### FIELD OF THE INVENTION

The invention relates to a rolling body cage for a ball bearing in the shape of a ring having receptacles that are distributed over the periphery for retaining and guiding the rolling bodies.

### BACKGROUND OF THE INVENTION

A rolling body cage of this type is known from DE 199 37 664 A1, which describes a synthetic material snap cage for a radial ball bearing, which snap cage comprises shell-like pockets which receive the ball bearings, are open in the axial direction and are distributed over the periphery.

One disadvantage of this embodiment is the fact that the solid, shell-like construction requires a large amount of material to be used and at the seine time requires a large amount of installation space, whereby on the one hand high costs are incurred and on the other hand it is difficult to introduce a lubricant into the bearing inner space, in particular, in the case of bearings that are lubricated with grease, only a small amount of grease retention space can be achieved. In addition, the shell-like pocket shape can only be manufactured at a high cost and complexity and it can render it difficult when assembling the ball hearings to push said bearings into the pockets.

### OBJECT OF THE INVENTION

The object of the invention is therefore to provide a rolling body cage of the aforementioned type that is simple and cost-effective to produce with respect to its construction, its manufacture and the assembly of the rolling bodies.

### DESCRIPTION OF THE INVENTION

The object is achieved by virtue of the features of claim 1 and alternatively by virtue of the features of claim 9 or 12.

In accordance with the invention; a rolling body cage for a ball bearing is proposed, wherein the receptacles for retaining and guiding the rolling bodies are implemented as cut-outs or recesses that form in each case at least one spherically curved encircling retaining edge that is matched to the spherical surface of the rolling bodies, at which edge the robing bodies can be snapped in an elastic manner into the cut-out or recess. In so doing, the rolling bodies can be engaged around by the retaining edge in a self-retaining manner by the retaining edge along an unbroken line that reaches beyond the ball bearing equator at a plurality of places, wherein in the region of the cut-out the rolling body can come into contact with the race of the bearing ring, without the rolling body cage contacting said race. The rolling body cage can be pre-assembled to form a ball bearing ring by virtue of the fact that the rolling bodies are retained in an elastic manner in the cut-outs in a simple manner. At the same time, the cut-outs can be manufactured in the ring in a simple manner.

The robing body cage is preferably implemented in metal plate and can be manufactured in a cost-effective, non-machining manner using methods for processing metal plate. For example, the cut-outs for receiving the rolling bodies can be simply die cut in the metal plate. At the same time, the embodiment in steel plate ensures a high level of temperature resistance.

A further preferred embodiment of the invention proposes to embody the ring in the axial direction with a substantially omega-shaped profile. As a consequence, this comprises a curvature that extends substantially in an omega-shape between the rims. The ring shape that is curved in an omega-shape between the rims engages around the spherical surface of the rolling bodies at the retaining edges of the cut-outs along an unbroken line. At the same time, the ring shape that is radially curved in an omega-shape renders it possible to assemble the rolling bodies in a particularly simple manner on its side open in a mouth-like manner between the rims. In addition, the omega-shaped profile can be matched in a simple manner to the conditions relating to the installation space of the bearing and to the dimensions of the rolling bodies. In the case of an embodiment in metal plate, the profiling of the ring can be achieved in a particularly simple manner by rolling.

Preferably, the retaining edge comprises spherically curved peripheral arc segments that face the rims and extend substantially in the direction of the periphery. These are mutually connected to form an unbroken line by means of spherically curved longitudinal arc segments that extend substantially in the axial longitudinal direction. In this manner, the retaining edge is matched to the spherical surface of the rolling bodies, wherein the rolling bodies are guided and retained at the spherically curved peripheral arc segments and longitudinal arc segments respectively. As a consequence, the rolling bodies are retained and guided at the retaining edge in a so-called four-point manner.

The use of a high-tensile material, such as in particular steel plate, renders possible an installation space-saving embodiment of the rolling body cage having a smaller material cross-section. It is particularly possible to reduce the cross-sectional profile of the webs down to a square or approximately square cross-section in the direction of the periphery. As a consequence, a greater number of rolling bodies can be arranged in the rolling body cage, whereby the load rating is increased and the serviceable life of the bearing is increased. In addition, the small material cross-section offers the option of using more lubricant in the case of bearings that are lubricated with grease and of increasing the grease retention space, whereby the serviceable life of the bearing can be further increased.

A particular protection against wear on the rolling body cage can be achieved by virtue of a surface treatment, in particular by surface hardening the steel plate, such as nitro carburizing. Alternatively, it is possible to provide a wear-resistant coating on the ring, in particular as a steel coating, e.g, Korotex.

Preferably, the ring comprises an omega-shaped profile that is curved radially inwards and whose open omega side faces radially outwards. As a consequence, the rolling bodies can be pushed in at the radial outer side of the ring from radially outwards to radially inwards into the cut-outs in the rolling body cage.

It is particularly advantageous if the ring is implemented in one piece. As a consequence, the construction of the rolling body cage is further simplified and the assembly costs and complexity and the manufacturing costs are further reduced.

In a further particular embodiment of the invention, the rims of the ring are implemented with different diameters for matching the rolling body cage to an inclined ball bearing. In this manner, the ring can be matched in a simple manner in particular at the rims to the elevations on the bearing rings, which elevations are necessary in order to embody the inclined races in the inclined ball bearings, and to the respective different diameters thereon resulting from this.

According to a further aspect of the invention, a method for manufacturing receptacles that are distributed over the periphery for retaining and guiding the rolling bodies on a rolling body cage for a ball bearing in the shape of a ring is proposed, in which method a number of elliptical-shaped cut-outs corresponding to the subsequent number of rolling bodies of the ball bearing are die cut in a steel plate disk or in a steel plate strip. The steel plate disc or the steel plate strip is formed by a metal forming process into a substantially omega-shaped longitudinally profiled ring shape, such that in each case at least one spherically curved encircling retaining edge that is matched to the spherical surface of the rolling bodies is produced on the cut-outs.

The cut-outs can be die cut lying one behind the other in a ring shape in the steel plate disc in a region that corresponds to the subsequent ring of the rolling body cage. When manufacturing from a steel plate strip, it is possible to perform a continuous die cutting process in the longitudinal direction.

Preferably, the profiling of the steel plate disc and the steel plate strip respectively is performed in one or a plurality of bending steps, in particular by profile rolling. In so doing, the steel plate disc can be profiled in a ring-shaped manner with the desired profile in a ring-shaped region that corresponds to the subsequent ring and that is die cut prior to or subsequently to the profiling process. The profiling of the steel plate strip can be provided along its width, wherein the cut length of the steel plate strip is formed into the desired longitudinally profiled ring shape by circular bending and it can be welded at its ends or connected by means of a positive locking connection or a positive/non-positive locking connection.

The ring-shaped profiling of the steel plate disc or the profiling and the circular bending of the steel plate strip produces on the originally elliptically-shaped cut-outs in each case a spherically curved retaining edge that is matched to the spherical surface of the rolling bodies.

Alternatively, the cut-outs can also be die cut in the steel plate disc or in the steel plate strip once they have been profiled, or rather the steel plate disc and the steel plate strip can be profiled prior said die cutting process.

The aforementioned method steps can be performed using a so-called follow-on tool one behind the other in a machine. For this purpose, it can possibly be expedient to align the steel plate disc or the steel plate strip as they are introduced into the follow-on tool or afterwards.

The rolling body cage can be manufactured in a particularly simple and cost-effective manner from a thin-walled continuous steel band. The manufacturing process can be further simplified if a steel band that is pre-profiled over its width corresponding to the omega-shaped profile of the subsequent ring is used. It is also feasible that a steel plate disc that is pre-bent at least partially corresponding to the omega-shaped profile of the subsequent ring is used for manufacturing the rolling body cage.

In this manner, a one-piece ball bearing snap cage can be manufactured in a cost-effective manner from a thin-walled steel plate in a non-machining manner.

In accordance with a further aspect of the invention, a method for assembling rolling bodies in a rolling body cage for a ball bearing in the shape of a ring having receptacles that are distributed over the periphery for retaining and guiding the rolling bodies is proposed, in which method the rolling bodies that can be snapped in in a self-retaining manner are pushed, at the radially open side of the substantially omega-shaped longitudinally profiled ring shape, by virtue of opening the rims thereof in an elastic manner, into the receptacles that are implemented as cut-outs. The radially curved ring shape renders it possible to assemble the rolling bodies in a particularly simple manner on its side that is open in a mouth-like manner between the rims.

### SHORT DESCRIPTION OF THE DRAWINGS

Further features of the invention are evident from the following description and the attached drawings, in which an exemplary embodiment of the invention is illustrated in a simplified manner and in which:

FIG. 1 shows a perspective illustration of a rolling body cage in accordance with the invention,

FIG. 2 shows a lateral view of the rolling body cage,

FIG. 3 shows a perspective illustration of a sectional view of the rolling body cage as seen from the inside,

FIG. 4 shows an enlarged sectional view of the rolling body cage from FIG. 3,

FIG. 5 shows a perspective illustration of the rolling body cage fitted with rolling bodies,

FIG. 6 shows a lateral view of the rolling body cage fitted with rolling bodies,

FIG. 7 shows a perspective illustration of a sectional view of the rolling body cage fitted with rolling bodies as seen from the inside,

FIG. 8 shows an enlarged sectional view of the rolling body cage fitted with rolling bodies from FIG. 3,

FIG. 9 shows a sectional view along the line X-X from FIG. 8,

FIG. 10 shows a longitudinal sectional view of the rolling body cage arranged in an inclined ball bearing,

FIG. 11 shows an enlarged sectional view from FIG. 10.

### DETAILED DESCRIPTION OF THE DRAWINGS

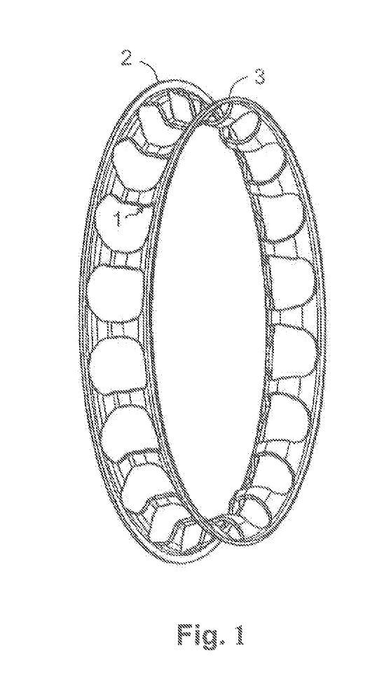

FIG. 1 shows a perspective illustration of a rolling body cage in accordance with the invention that is implemented as a ball bearing snap cage for an inclined ball bearing. The ball bearing snap cage is embodied in the shape of a ring in one piece in thin-walled steel plate and comprises a substantially omega-shaped longitudinal profile that is arranged with its open omega side directed radially outwards. As a consequence, a ring that is curved radially inwards between its rims 2, 3 is produced. The cut-outs that are arranged distributed over the periphery of the ring for receiving the rolling bodies have an elliptical shape in the plan view and form on their edges in each case retaining edges 1, against which the rolling bodies being received in the cut-outs are retained. The retaining edges 1 extend in each case along an unbroken line. This line extends between the rims 2, 3 of the ring along a spherical curve produced on the one hand by virtue of its omega-shaped longitudinal profile and on the other hand by virtue of its ring-shaped curve.

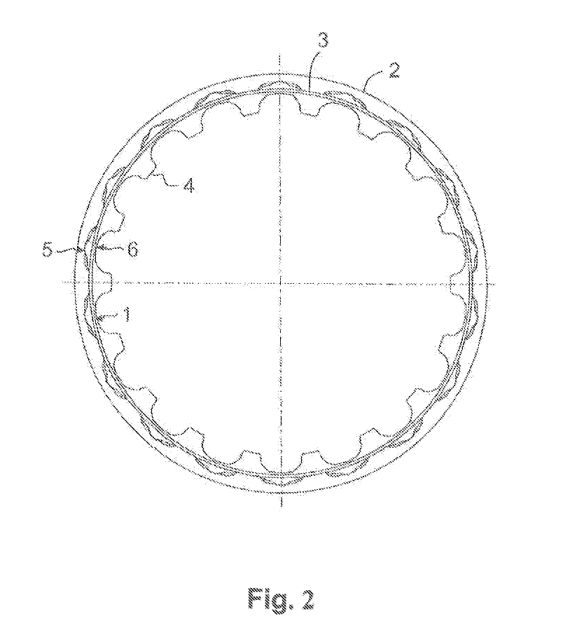

In the axial lateral view, the ring shape is clearly curved radially inwards between the rims 2, 3 (FIG. 2). The cut-outs are separated from each other in each case by the webs 4 connecting the rims 2, 3 of the ring and form on their edges facing the rims 2, 3 in each case spherically curved peripheral arc segments 5 of the retaining edge 1, which arc segments extend in the direction of the periphery of the ring and are matched to the spherical surface. The rims 2, 3 of the ring are implemented with different diameters for matching to the inclined ball bearing.

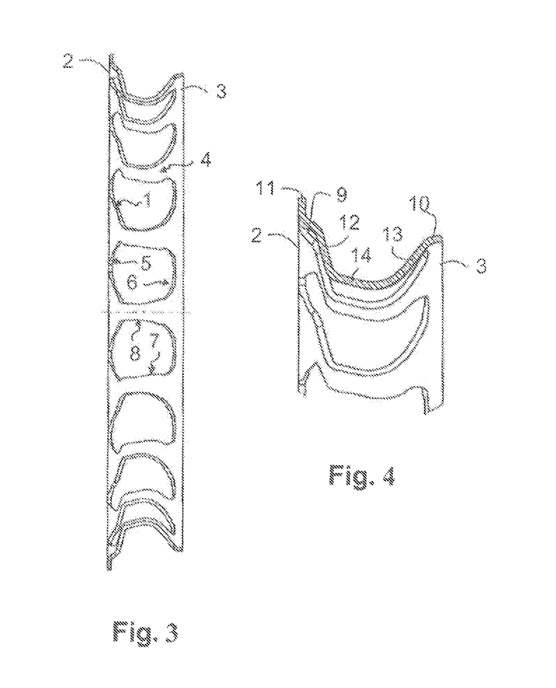

FIG. 3 illustrates a perspective sectional view of the rolling body cage as seen from the inside. The original planar elliptical basic shape of the cut-outs is clearly evident in the plan view, which cut-outs by virtue of the radially inwardly curved omega-shaped profiling and the circular bending into the ring shape form in each case a retaining edge 1 that extends along a spherically curved unbroken line. This retaining edge 1 comprises in each case spherically curved peripheral arc segments 5, 6 that face the rims 2, 3 and are mutually connected to form an unbroken line by means of the spherically curved longitudinal arc segments 7, 8 that extend along the webs 4 in the axial direction and are matched to the spherical surface.

The enlarged sectional view in FIG. 4 shows the substantially omega-shaped longitudinal profile of the ring. This forms in the region of the rims 2, 3 edge sections 9, that extend approximately in the axial direction as omega feet, wherein the rim 2 that is implemented with the larger diameter comprises an end section 11 that extends radially outwards. The omega bulge opening radially outwards and lying between the omega feet is embodied by two flanks 12, 13 that are of approximately equal length and starting from the omega feet each extend converging towards each other in a radially inwards inclined manner, said flanks being mutually connected by an axial longitudinal section 14 that is slightly inclined towards the rim 3 that has the smaller diameter.

As a consequence, the omega bulge extends, differently to the conventional shape of the omega, slightly extended in the axial direction and slightly inclined towards the rim 3 that has the smaller diameter.

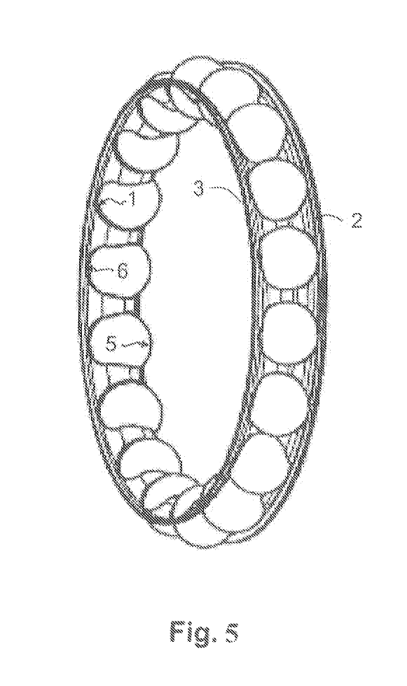

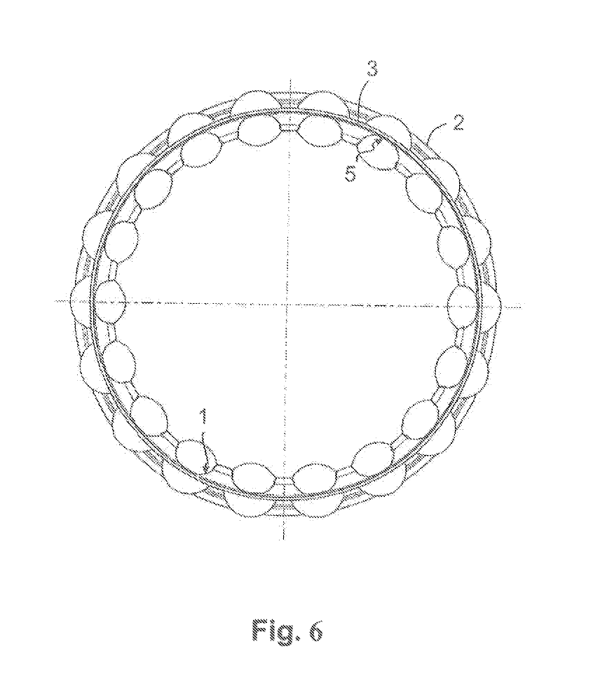

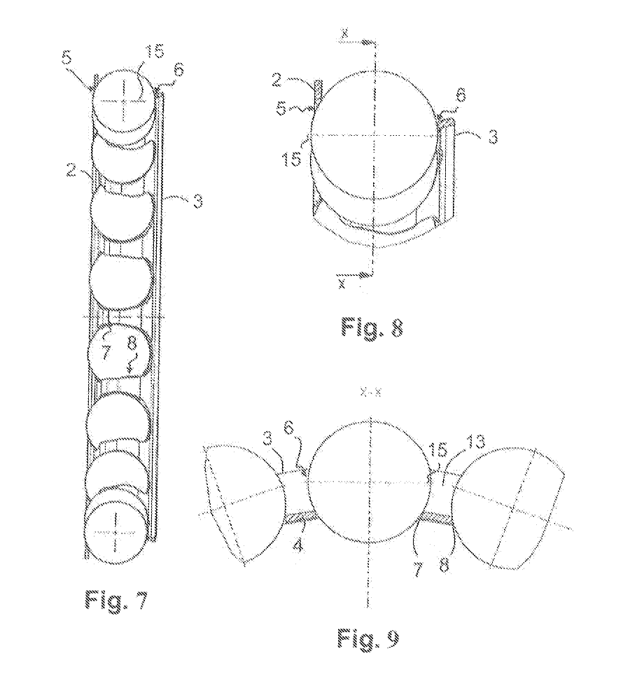

FIGS. 5, 6 and 7 illustrate a perspective view of the ball bearing snap cage pre-assembled with rolling bodies. The rolling bodies are retained in the cut-outs, engaged around in each case by the spherically curved retaining edges 1. For assembly purposes, the rolling bodies can be pushed from radially outwards towards radially inwards into the cut-outs by virtue of opening the rims 2, 3 in an elastic manner and by snapping the retaining edges 1 on in an elastic manner. As soon as the retaining edge 1 reaches beyond the ball bearing equator 15 at the peripheral arc segments 5, 6, it snaps back in an elastic manner, whereby the ball bearing is retained in a self-retaining manner in the cut-out. The radially inwardly curved retaining edge 1 nestles in a spherically curved manner against the spherical surface of the roiling bodies and in so doing clearly covers or extends beyond the ball bearing equator 15 at its peripheral arc segments 5, 6 and at the longitudinal arc segments 7, 8. As a consequence, the rolling bodies are retained and guided at the retaining edge 1 of the cut-out in a so-called four-point manner.

The enlarged sectional view in FIG. 8 clearly shows once again how said retaining edge 1 covers or extends beyond the ball bearing equator 15 at the peripheral arc segments 5, 6 of the retaining edge 1 in the region of the rims 2, 3 of the ring.

FIG. 9 illustrates a sectional view of the rolling body cage on the webs 4 in each case in the direction of the periphery along the line X-X. Starting from the radially inwardly lying webs 4, the longitudinal profile of the ring and the retaining edges 1, which follow this profile, of the cut-outs in the flank 13 extend rising in the radially outwards direction towards the rim 3 that has the smaller diameter. In so doing, the rolling bodies are retained and guided in the direction of the periphery in the cut-outs at the longitudinal arc segment 7 of the retaining edge 1. In the region of the smaller rim 3, the retaining edge 1 reaches beyond the ball bearing equator 15 at its peripheral arc segment 6. The material cross-section in the direction of the periphery of the webs 4 can possibly be reduced to a square cross-section, in order to be able to increase the number of rolling bodies requiring the same amount of installation space.

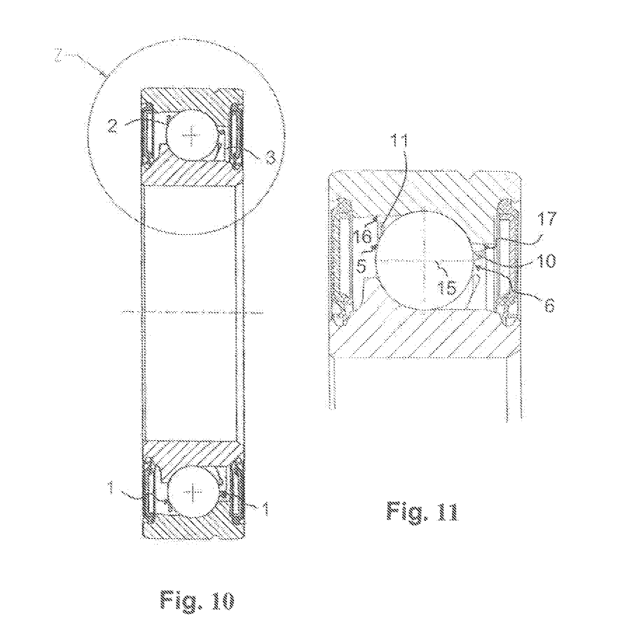

FIG. 10 shows a longitudinal sectional view of the ball bearing snap cage pre-assembled with rolling bodies and in an inclined ball bearing. The ball bearings run along the inclined races that are embodied on elevations on the bearing rings. The rolling bodies received in the cut-outs of the ring have an amount of clearance in all directions. As a consequence, they can adjust themselves in the inclined races. The ball bearing snap cage is implemented in a ring shape that matches the shape of the elevations on the bearing rings and is fully supported, guided by the rolling bodies, by way of the rolling bodies. The rolling bodies that are engaged around in the cut-outs of the ring by the retaining edges 1 are radially outwards and radially inwards in contact with the inclined races of the bearing rings of the inclined ball bearing, without them in so doing contacting the rolling body cage. For this purpose, the diameter of the rim 2 is matched to the larger diameter of the side 16 of the outer bearing ring, which side 16 is implemented without elevations, and which rim 2 is arranged with its radial end section 11 facing this side 16 with an amount of radial clearance, whereas the diameter of the rim 3 is matched to the smaller diameter of the side 17 of the outer bearing ring, which side 17 is implemented with an elevation, and which rim 3 is arranged at the approximately axially extending edge section 10 facing this side 17 with a certain amount of radial clearance (FIG. 11). In so doing, the peripheral are segments 5, 6 of the retaining edge 1 are implemented on the cut-outs in the region of the rims 2, 3 radially outwards to such an extent that they cover or reach beyond the ball bearing equator 15 and engage around the roiling body in a self-retaining manner in the cut-out. At the same time, the rims 2, 3 comprise in each case sufficient clearance in the axial direction towards the bearing sealing arrangements. The thin-walled ring of the ball bearing snap cage requires less installation space, so that a large amount of space remains in the bearing for introducing a lubricant and thus in the case of bearings that are lubricated with grease a high grease retention space is ensured.

### LIST OF DESIGNATIONS

1 Retaining Edge
2 Rim
3 Rim
4 Web
5 Peripheral Arc Segment
6 Peripheral Arc Segment
7 Longitudinal Arc Segment
8 Longitudinal Arc Segment
9 Edge Section
10 Edge Section
11 End Section
12 Flank
13 Flank
14 Longitudinal Section
15 Ball Bearing Equator
16 Side
17 Side

1-11. (canceled)

13. A roiling body, cage for a ball bearing, comprising:
a ring having receptacles distributed over a periphery of the cage for retaining and guiding rolling bodies that each have a spherical surface,
wherein the receptacles are cut-outs that each form at least one spherically curved encircling retaining edge that is matched to the spherical surface of the rolling bodies, and at the retaining edge, the rolling bodies are mappable in a self-retaining manner in the cut-outs such that the rolling bodies are engagable by the retaining edge.

14. The rolling body cage as claimed in claim 13, wherein the ring is a in metal plate.

15. The rolling body cage as claimed in claim 13, wherein the ring comprises, in an axial direction, a substantially omega-shaped cross-sectional profile.

16. The rolling body cage as claimed in claim 13, wherein the ring has rims and the retaining edge has spherically curved peripheral arc segments that face the rims and extend substantially in a direction of the periphery of the cage, the peripheral arc segments are mutually connected by spherically curved longitudinal arc segments that extend substantially in a longitudinal direction, and the rolling bodies are guidable and retained at the longitudinal arc segments and the spherically curved peripheral arc segments that are each matched to the spherical surface of the rolling bodies.

17. The rolling body cage as claimed in claim 16, further comprising webs with an at least substantially square cross-sectional profile, the webs being formed between the cut-outs and connect the rims of the ring to each other.

18. The rolling body cage as claimed in claim 13, wherein the ring is surface-hardened or coated to provide protection against wear.

19. The rolling body cage as claimed in claim 13, wherein the ring is constructed as one piece.

20. The rolling body cage as claimed in claim 16, wherein the rims of the ring have different diameters for matching the ring to an inclined ball bearing.

21. A method for manufacturing receptacles that are distributed over a periphery for retaining and guiding rolling bodies on a rolling body cage for a ball bearing in a shape of a ring, the method comprising the following steps:
die cutting a plurality of elliptical-shaped cut-outs corresponding to a plurality of rolling bodies of the ball bearing in a steel plate disk or in a steel plate strip; and
forming the steel plate disk or the steel plate strip by a metal forming process into a substantially omega-shaped longitudinally profiled ring shape such that at least one spherically curved encircling retaining edge that is matched to the spherical surface of the rolling bodies is produced on the cut-outs.

22. The method as claimed in claim 21, including forming the steel plate disk or the steel plate strip into the substantially omega-shaped longitudinally profiled ring by ring-shaped profiling or by profiling along a width of the steel plate disk or the steel plate strip and by circular bending in at least one bending step.

23. The method as claimed in claim 21, including forming the steel plate disk or the steel plate strip into the substantially omega-shaped longitudinally profiled ring by ring-shaped profiling or by profiling along a width of the steel plate disk or the steel plate strip and by profile rolling in at least one bending step.

24. The method as claimed in claim 21, including using a thin-walled steel band that is pre-profiled over a width corresponding to the substantially omega-shaped profile of the subsequent ring.

25. A method for assembling rolling bodies in a rolling body cage for a ball bearing, the cage having a substantially omega-shaped longitudinally profiled ring shape with rims and receptacles that are cut-outs distributed over a periphery of the cage for retaining and guiding the rolling bodies, the method comprising the step of:
pushing the rolling bodies into the receptacles of the cage at a radially open side of the substantially omega-shaped longitudinally profiled ring shape such that the rims are elastically deformed and the rolling bodies snap into the receptacles and are held in a self-retaining manner.
